(19) United States
(12) Patent Application Publication
(10) Pub. No.: US 2004/0077309 A1
(43) Pub. Date: Apr. 22, 2004

(54) Wireless signal forwarder

(76) Inventors: Richard Brass, Seattle, WA (US); David Wecker, Redmond, WA (US)

Correspondence Address: LEE & HAYES PLLC, 421 W RIVERSIDE AVENUE SUITE 500, SPOKANE, WA, 99201

(21) Appl. No.: 10/273,749

(22) Filed: Oct. 18, 2002

(51) Int. Cl. H04B 3/36; H04B 7/14

(52) U.S. Cl. 455/7; 370/351

(57) ABSTRACT

An implementation of a technology, described herein, for wireless signal transmission and/or reception. One of the implementations, described herein, wirelessly couples a wireless device to a non-co-located antenna. This non-co-located antenna receives long-range wireless signals. It converts those signals into a short-range wireless signal and transmits them to the non-co-located wireless device. This abstract itself is not intended to limit the scope of this patent. The scope of the present invention is pointed out in the appending claims.

### TECHNICAL FIELD

This invention generally relates to a technology for wireless signal transmission and/or reception.

### BACKGROUND

Although fanciful futuristic vehicles are often depicted in science fiction with a large degree of computing power, the present reality of science fact involves the convergence of computers, the communications infrastructure, and automobiles. Such convergence currently includes or may soon include the following technologies (by way of example only):

satellite feeds that include audio, video, and data;

virtual navigation;

remote vehicle diagnostics and control;

Internet access;

personal communication services (PCS) like cellular phone and pager systems;

games;

remote feature access (RFA) like keyless entry;

global positioning system (GPS);

mobile office;

local radio and television broadcasts; and

real-time data access (e.g., stock quotes and sports scores).

The transmission and reception of electromagnetic waves (e.g., satellite signals) out of and into a vehicle is typically conducted through a multitude of antennas. Some of these antennas are attached to the exterior of the vehicle. Some to the interior. And still others are attached to devices (e.g., cell phones and GPS devices) within the vehicle.

### Exterior Vehicular Antennas

Typical automobile vehicles are effectively metal boxes. Consequently, they often act like Faraday shields (i.e., Faraday cages). Those of ordinary skill in the art understand the affect that Faraday shields have on electromagnetic waves (i.e., signals) attempting to pass through. In short, they abate incoming and outgoing signals. That is why vehicular antennas (such as for AM/FM radio) typically are mounted to the exterior.

Another reason for popularity of exterior antennas is the “shadow antenna” effect. Mounting an antenna on the metal exterior of a vehicle produces this effect. This virtually doubles the length of the antenna, thereby greatly enhancing its effectiveness. Therefore, an antenna externally mounted to the metal body of a vehicle is typically much more effective than one mounted internally.

### Interior Vehicular Antennas

Despite the superiority of externally mounted vehicular antennas, a vehicle may have interior antennas. Typically, these antennas are part of portable wireless devices which may be used outside the context of a vehicle, as well. Examples of such wireless devices include a cellular phone, personal digital assistant (PDA), PocketPC®, TabletPC™, and a laptop computer.

Typically, interior vehicular antennas (like those on the devices listed above) only pick up the strongest of signals. An example of a weak signal that is difficult to receive inside a vehicle is a satellite transmission. One popular use of satellite signals is for the Global Positioning System (GPS).

To determine a location doing GPS triangulation, the receiver must pick up at least three satellite signals, but more is preferable. In addition, the metal roof of an automobile further abates a satellite signal. That is because the signals must penetrate the metal roof of a typical automobile.

Those who are skilled in the art are aware that antennas inside a vehicle are generally less likely to receive long-range signals than those mounted to the exterior.

### Conventional Solution: External Hard-Wired Antenna

Problem: Enabling a wireless device inside a vehicle (thus, it has an interior vehicular antenna) to effectively communicate with the wireless world outside the confines of the vehicle.

The conventional solution: Hard-wire the wireless device to an external fixed antenna.

The conventional solution involves mounting an external fixed antenna to a vehicle. Drill one or more holes through the vehicular shell and into the passenger compartment. Then run unsightly wire through one or more holes and into the compartment. Connect the wire to the external antenna and the previously-wireless-but-now-effectively-wired interior device.

### SUMMARY

Described herein is a technology for wireless signal transmission and/or reception.

One of the implementations, described herein, wirelessly couples a wireless device (e.g., GPS navigation device) to a non-co-located antenna. This non-co-located antenna receives long-range wireless signals that the wireless device either does not receive or has difficulty receiving. It converts those signals into a short-range wireless signal and transmits them to the non-co-located wireless device.

With one of the implementations, described herein, the signal direction is reversed so that the non-co-located antenna transmits the wireless device's converted signal.

One of the implementations, described herein, is a signal-forwarding intermediary (“hub”) configured to be temporarily mounted on the exterior of an automobile. Via this hub, the physically untethered devices inside the automobile communicate with the wireless world outside the automobile (e.g., such with a GPS satellite).

This summary itself is not intended to limit the scope of this patent. Moreover, the title of this patent is not intended to limit the scope of this patent. For a better understanding of the present invention, please see the following detailed description and appending claims, taken in conjunction with the accompanying drawings. The scope of the present invention is pointed out in the appending claims.

### BRIEF DESCRIPTION OF THE DRAWINGS

The same numbers are used throughout the drawings to reference like elements and features.

FIG. 1 is an example of a signal-forwarding architecture in accordance with an implementation described herein.

FIG. 2 is a block diagram illustrating an example of a signal-forwarding intermediary (a “hub”) in accordance with an implementation described herein.

FIG. 3 is a flow diagram showing a methodological implementation described herein.

FIG. 4 is an example of a computing operating environment capable of (wholly or partially) implementing at least one embodiment described herein.

### DETAILED DESCRIPTION

In the following description, for purposes of explanation, specific numbers, materials and configurations are set forth in order to provide a thorough understanding of the present invention. However, it will be apparent to one skilled in the art that the present invention may be practiced without the specific exemplary details. In other instances, well-known features are omitted or simplified to clarify the description of the exemplary implementations of present invention, thereby better explain the present invention. Furthermore, for ease of understanding, certain method steps are delineated as separate steps; however, these separately delineated steps should not be construed as necessarily order dependent in their performance.

The following description sets forth one or more exemplary implementations of a Wireless Signal Forwarder that incorporate elements recited in the appended claims. These implementations are described with specificity in order to meet statutory written description, enablement, and best-mode requirements. However, the description itself is not intended to limit the scope of this patent.

The inventors intend these exemplary implementations to be examples. The inventors do not intend these exemplary implementations to limit the scope of the claimed present invention. Rather, the inventors have contemplated that the claimed present invention might also be embodied and implemented in other ways, in conjunction with other present or future technologies.

An example of an embodiment of a Wireless Signal Forwarder may be referred to as an “exemplary forwarder.”

### Introduction

The bulk of the discussion herein is focused on a particular environment within which the exemplary forwarder may be employed. Namely, that exemplary environment is within the context of an automobile vehicle.

However, the exemplary forwarder may be employed within other context where part of that environment hinders wireless signal transmission from within a confined area. Generally, this includes any other area exhibiting the characteristics of Faraday shields. Examples include houses, tunnels, buildings, canyons, etc.

More generally still, the exemplary forwarder may be employed within other context where it is not convenient or desirable for the antenna transmitting or receiving a wireless signal to be co-located with the wireless device originating or ultimately consuming that signal.

Therefore, those who are skilled in the art understand and appreciate that the discussion focused on use within the automobile environments may be extended to other similarly situated environments. That is true unless, of course, the context of the discussion distinguishes the use in the automobile environments from others.

### Overview

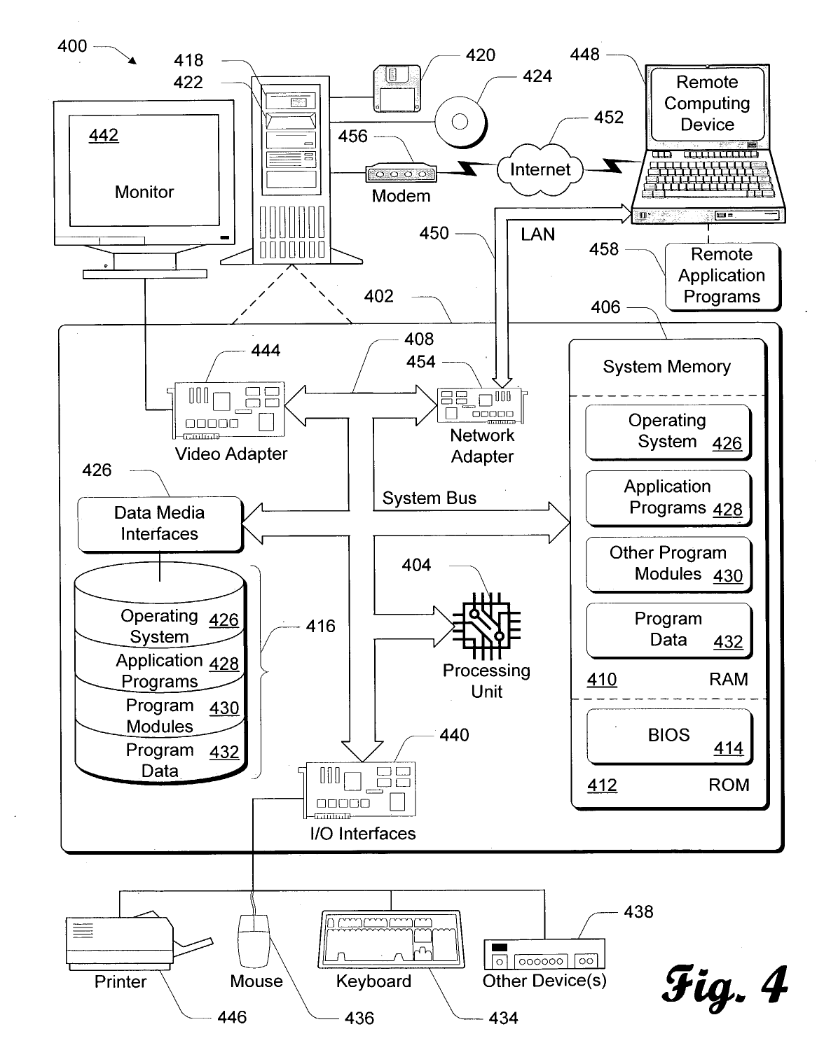

The one or more exemplary implementations, described herein, of the present claimed invention may be implemented (in whole or in part) by a signal-forwarding architecture 100 and/or by a computing environment like that shown in FIG. 4.

The exemplary forwarder relates to transmission of wireless signals to and/or from portable devices within a vehicle. Existing solutions are typically hard-wired with permanent antennas transmitting signals via hard wires to a single device in the vehicle.

There are times when person would like to interact with external information sources (e.g., GPS, cell phone, data networks) while inside a vehicle, but limit the impact on both the vehicle and the passengers. These people have a desire to access data in a portable manner. For example, this may be while they are traveling, while they are in a vehicle that they do not own (e.g., a rent-a-car), when they change vehicles frequently, etc.

For example, a person may wish use navigation equipment while inside an automobile. However, his portable GPS device may have great difficulty receiving the appropriate satellite signals. This person may not want to go through the hassle of mounting an external antenna and running unsightly and tangle-prone wire back to his GPS device.

In some conventional instances, the wired antenna is mounted inside the vehicle but in a specific (and often inconvenient) position of the windshield or other interior glass. Still, there is wire connecting the antenna to the device. In addition to the wire being unsightly and entanglement-prone, the mounted antenna may be a safety risk because it blocks the driver's clear view through the windows.

The exemplary forwarder provides a solution for these situations.

In general, the solution provided by the exemplary forwarder is wirelessly coupling the wireless device (e.g., GPS device) inside the vehicle to an antenna on the exterior of the vehicle. Free from the Faraday cage effect (of the vehicle) and boosted by the “shadow antenna” effect, this exteriorly mounted antenna forwards wireless signals from/to the interior wireless device. This approach eliminates the burden of running ungainly wire between the interior device and the exterior antenna.

Therefore, the exemplary forwarder enables a wireless device inside a vehicle to communicate wirelessly with the wireless world outside the confines of the vehicle.

### Exemplary Signal-Forwarding Architecture

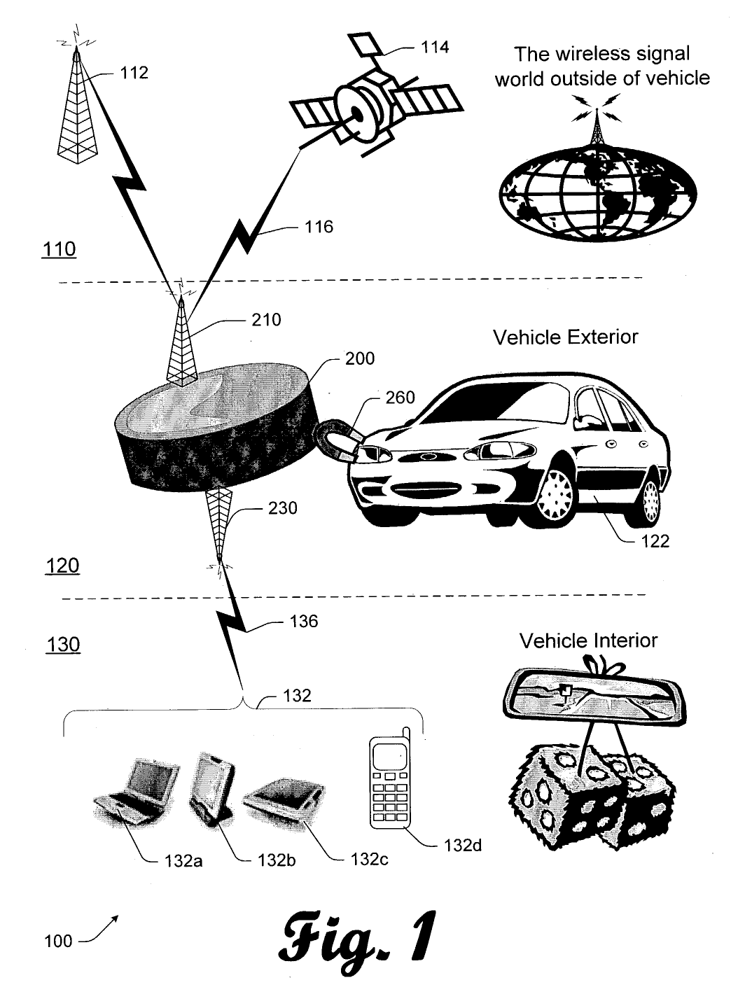

FIG. 1 illustrates the signal-forwarding architecture 100 within the context of an automobile environment.

As shown in FIG. 1, the signal-forwarding architecture 100 includes the wireless-signal-world 110 outside the vehicle, the vehicle exterior environment 120, and the vehicle interior environment 130. It bears repeating that is just one example of an architecture implementing the exemplary forwarder.

The wireless-signal-world 110 may include the full-range of wireless services, their transmitters, and receivers. For example, it may include cell phone towers 112 and GPS satellites 114.

The vehicle exterior environment 120 includes an autonomous signal intermediary 200—which may be called a “hub”—affixed to the exterior of the vehicle 122. The hub 200 may be permanently affixed to the vehicle exterior using most any conventional means, such as adhesive, rivets, screw fasteners, clamp fasteners, etc. As shown in FIG. 1, the hub 200 is temporarily affixed to the vehicle exterior using a magnetic affixation 260 or another conventional temporary affixation means.

Alternatively, the hub 200 may also be permanently or temporarily mounted to the interior of the vehicle when its operation is not significantly compromised. For example, the hub may be affixed—using a suction cup—to the glass interior with an unobstructed “view” of the transmitter in the wireless-signal world (e.g., satellite 114).

The major advantage of temporary over permanent affixation is portability and convenience. A portable hub may be easily transported to, attached to, and used with any other vehicle. This is particularly useful to a person that frequently drives more than one vehicle. This is commonly the case when people travel and rent cars.

The hub includes a long-range antenna 210 for sending/receiving wireless signals to receivers/transmitters in the wireless-signal-world 110. The signals employed by the long-range services in the wireless-signal-world 110 typically are relatively weak signals that are designed to travel great distances. For example, GPS signals 116 from the satellite 114.

The hub also includes a short-range antenna 230 for sending/receiving wireless signals to wireless devices 132 in the vehicle. The signals 136 employed here for short-range services typically are relatively strong signals designed to travel very short distances. For example, Bluetooth employs such a signal.

The vehicle interior environment 130 includes one or more wireless devices 132. FIG. 1 shows a laptop computer 132a, an Internet appliance 132b, a TabletPC™ 132c, and a cell phone 132d. Other examples of local wireless devices include a personal digital assistant (PDA), a PocketPC®, and a GPS device.

These devices 132 have an antenna for localized wireless signal transmission (e.g., Bluetooth) with the hub 200. These devices may have a “virtual corn port” so that it may wireless communicate with the wireless-signal-world 110 via its antenna and the hub 200. Alternatively, these devices may communicate with an internal vehicular bus.

### Exemplary Signal Intermediary (“Hub”)

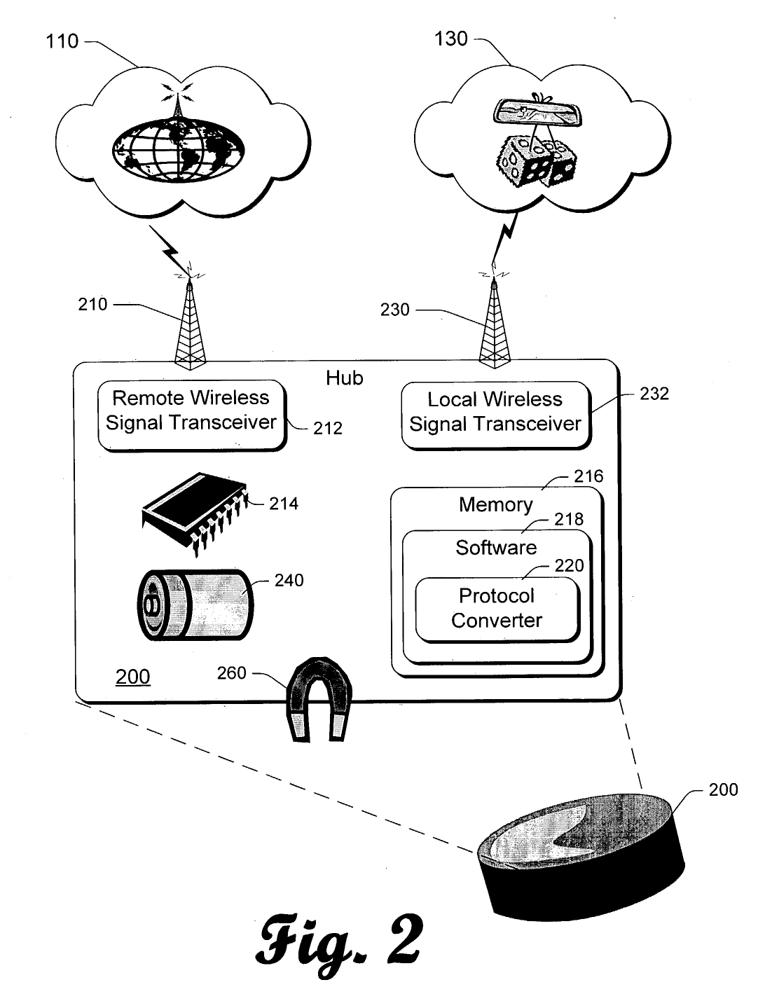

FIG. 2 shows more detail of the exemplary signal intermediary (“hub”) 200. This hub includes a remote-wireless-signal antenna 210 for one or more long-range wireless services (e.g., GPS, GPRS, IEEE 802.11) and a transmitter and receiver (“transceiver”) 212 for those services.

This transceiver 212 is a long-range signal receiver, transmitter, and/or both and it is a protocol decoder for such a long-range signal. With these components, the hub 200 communicates with the wireless-signal-world 110 outside of the vehicular environment.

The hub has a processor 214 and a memory 216. Loaded in this memory are system software 218 and other software modules, such as a protocol converter module 220.

Furthermore, the hub 200 includes a local-wireless-signal antenna 230 for one or more short-range wireless services and a transmitter and receiver (“transceiver”) 232 for those services. This transceiver 232 is a short-range signal receiver, transmitter, and/or both and it is a protocol decoder for such a short-range signal.

Examples of such short-range services include BlueTooth (IEEE 802.15.4), IEEE 802.11, and IR (with this option a line-of-sight hood-mounted unit is very appropriate). The hub uses local pointed or directed signals to/from the local wireless devices. Typically, these signals are powerful enough for reliable communication over the short distance between the inside and outside of the vehicle. Typically, these signals are very high frequency (e.g., 2.4 GHz). Therefore, it can penetrate the material between the devices and the hub.

With these local-wireless-signal components, the hub 200 communicates with the local wireless devices inside the interior vehicular environment 130. Examples of such local devices include a cellular phone, a personal digital assistant (PDA), a PocketPC®, a TabletPC™, a GPS device, and a laptop computer.

Moreover, the hub has a power source 240, such as one or more batteries. The hub has an affixation mechanism, such as magnetic affixation 260 shown in FIG. 2, for mounting the hub to the exterior of the vehicle.

Using a long-range wireless service (e.g., like that used by satellites), the hub 200 receives signals from the world 110 outside the realm of the vehicle. The hub converts this signal for transmission via a short-range wireless service (e.g., Bluetooth). Such conversion is accomplished by the processor and program modules, such as protocol converter 220. The hub forwards to the converted signal to local devices. The hub may perform the same operations for transmitting signals to the world outside the context of the vehicle.

### Methodological Implementation of the Exemplary Signal-Forwarding

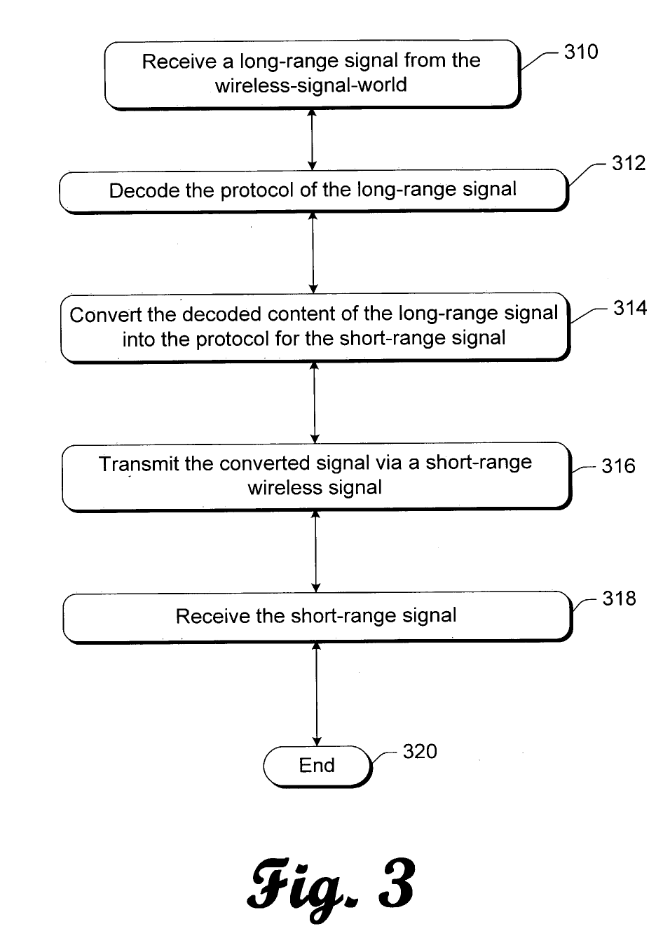

FIG. 3 shows methodological implementation of the exemplary forwarder performed by the signal-forwarding architecture 100 (or some portion thereof). This methodological implementation may be performed in software, hardware, or a combination thereof.

At 310 of FIG. 3, the exemplary forwarder receives a long-range wireless service from the wireless-signal-world 110.

At 312, it decodes the protocol of the long-range wireless service.

At 314, the exemplary forwarder converts the decoded content of the long-range wireless service into the protocol for the short-range wireless service.

At 316, it transmits the converted signal via a short-range wireless service.

At 318 of FIG. 3, the local wireless devices in the vehicle interior environment 130 receive the short-range service.

At 320 the process ends. Of course, this process is reversed for transmissions from the local wireless device to the wireless-signal-world 110.

### Exemplary Computing System and Environment

FIG. 4 illustrates an example of a suitable computing environment 400 within which an exemplary forwarder, as described herein, may be implemented (either fully or partially). The computing environment 400 may be utilized in the computer and network architectures described herein. Within the context of the signal-forwarding architecture 100, the computing environment 400 includes exemplary signal intermediary (“hub”) 200.

The exemplary computing environment 400 is only one example of a computing environment and is not intended to suggest any limitation as to the scope of use or functionality of the computer and network architectures. Neither should the computing environment 400 be interpreted as having any dependency or requirement relating to any one or combination of components illustrated in the exemplary computing environment 400.

The exemplary forwarder may be implemented with numerous other general purpose or special purpose computing system environments or configurations. Examples of well known computing systems, environments, and/or configurations that may be suitable for use include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary forwarder may be described in the general context of computer-executable instructions, such as program modules, being executed by a computer. Generally, program modules include routines, programs, objects, components, data structures, etc. that perform particular tasks or implement particular abstract data types. The exemplary forwarder may also be practiced in distributed computing environments where tasks are performed by remote processing devices that are linked through a communications network. In a distributed computing environment, program modules may be located in both local and remote computer storage media including memory storage devices.

The computing environment 400 includes a general-purpose computing device in the form of a computer 402. The components of computer 402 may include, by are not limited to, one or more processors or processing units 404, a system memory 406, and a system bus 408 that couples various system components including the processor 404 to the system memory 406.

The system bus 408 represents one or more of any of several types of bus structures, including a memory bus or memory controller, a peripheral bus, an accelerated graphics port, and a processor or local bus using any of a variety of bus architectures. By way of example, such architectures may include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 402 typically includes a variety of computer readable media. Such media may be any available media that is accessible by computer 402 and includes both volatile and non-volatile media, removable and non-removable media.

The system memory 406 includes computer readable media in the form of volatile memory, such as random access memory (RAM) 410, and/or non-volatile memory, such as read only memory (ROM) 412. A basic input/output system (BIOS) 414, containing the basic routines that help to transfer information between elements within computer 402, such as during start-up, is stored in ROM 412. RAM 410 typically contains data and/or program modules that are immediately accessible to and/or presently operated on by the processing unit 404.

Computer 402 may also include other removable/non-removable, volatile/non-volatile computer storage media. By way of example, FIG. 4 illustrates a hard disk drive 416 for reading from and writing to a non-removable, non-volatile magnetic media (not shown), a magnetic disk drive 418 for reading from and writing to a removable, non-volatile magnetic disk 420 (e.g., a “floppy disk”), and an optical disk drive 422 for reading from and/or writing to a removable, non-volatile optical disk 424 such as a CD-ROM, DVD-ROM, or other optical media. The hard disk drive 416, magnetic disk drive 418, and optical disk drive 422 are each connected to the system bus 408 by one or more data media interfaces 426. Alternatively, the hard disk drive 416, magnetic disk drive 418, and optical disk drive 422 may be connected to the system bus 408 by one or more interfaces (not shown).

The disk drives and their associated computer-readable media provide non-volatile storage of computer readable instructions, data structures, program modules, and other data for computer 402. Although the example illustrates a hard disk 416, a removable magnetic disk 420, and a removable optical disk 424, it is to be appreciated that other types of computer readable media which may store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, may also be utilized to implement the exemplary computing system and environment.

Any number of program modules may be stored on the hard disk 416, magnetic disk 420, optical disk 424, ROM 412, and/or RAM 410, including by way of example, an operating system 426, one or more application programs 428, other program modules 430, and program data 432.

A user may enter commands and information into computer 402 via input devices such as a keyboard 434 and a pointing device 436 (e.g., a “mouse”). Other input devices 438 (not shown specifically) may include a microphone, joystick, game pad, satellite dish, serial port; scanner, and/or the like. These and other input devices are connected to the processing unit 404 via input/output interfaces 440 that are coupled to the system bus 408, but may be connected by other interface and bus structures, such as a parallel port, game port, or a universal serial bus (USB).

A monitor 442 or other type of display device may also be connected to the system bus 408 via an interface, such as a video adapter 444. In addition to the monitor 442, other output peripheral devices may include components such as speakers (not shown) and a printer 446 which may be connected to computer 402 via the input/output interfaces 440.

Computer 402 may operate in a networked environment using logical connections to one or more remote computers, such as a remote computing device 448. By way of example, the remote computing device 448 may be a personal computer, portable computer, a server, a router, a network computer, a peer device or other common network node, and the like. The remote computing device 448 is illustrated as a portable computer that may include many or all of the elements and features described herein relative to computer 402.

Logical connections between computer 402 and the remote computer 448 are depicted as a local area network (LAN) 450 and a general wide area network (WAN) 452. Such networking environments are commonplace in offices, enterprise-wide computer networks, intranets, and the Internet.

When implemented in a LAN networking environment, the computer 402 is connected to a local network 450 via a network interface or adapter 454. When implemented in a WAN networking environment, the computer 402 typically includes a modem 456 or other means for establishing communications over the wide network 452. The modem 456, which may be internal or external to computer 402, may be connected to the system bus 408 via the input/output interfaces 440 or other appropriate mechanisms. It is to be appreciated that the illustrated network connections are exemplary and that other means of establishing communication link(s) between the computers 402 and 448 may be employed.

In a networked environment, such as that illustrated with computing environment 400, program modules depicted relative to the computer 402, or portions thereof, may be stored in a remote memory storage device. By way of example, remote application programs 458 reside on a memory device of remote computer 448. For purposes of illustration, application programs and other executable program components such as the operating system are illustrated herein as discrete blocks, although it is recognized that such programs and components reside at various times in different storage components of the computing device 402, and are executed by the data processor(s) of the computer.

### Computer-Executable Instructions

An implementation of an exemplary forwarder may be described in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

### Exemplary Operating Environment

FIG. 4 illustrates an example of a suitable operating environment 400 in which an exemplary forwarder may be implemented. Specifically, the exemplary forwarder(s) described herein may be implemented (wholly or in part) by any program modules 428-430 and/or operating system 426 in FIG. 4 or a portion thereof.

The operating environment is only an example of a suitable operating environment and is not intended to suggest any limitation as to the scope or use of functionality of the exemplary forwarder(s) described herein. Other well known computing systems, environments, and/or configurations that are suitable for use include, but are not limited to, personal computers (PCs), server computers, hand-held or laptop devices, multiprocessor systems, microprocessor-based systems, programmable consumer electronics, wireless phones and equipments, general- and special-purpose appliances, application-specific integrated circuits (ASICs), network PCs, minicomputers, mainframe computers, distributed computing environments that include any of the above systems or devices, and the like.

### Computer Readable Media

An implementation of an exemplary forwarder may be stored on or transmitted across some form of computer readable media. Computer readable media may be any available media that may be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

### Conclusion

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A computer-readable medium having computer-executable instructions that, when executed by a computer, performs a method comprising:
receiving a long-range wireless service having a protocol for encoding data into a signal of the long-range wireless service;
decoding the protocol of the long-range wireless service;
converting the results of the decoding into a protocol of a short-range wireless service having a protocol for encoding data into a signal of the short-range wireless service;
sending the converted results via the short-range wireless service.

2. A medium as recited in claim 1, wherein the signal of the long-range wireless service is relatively weak compared to the signal of the short-range wireless service.

3. A medium as recited in claim 1, wherein, as compared to the signal of the short-range wireless service, the signal of the long-range wireless service is more easily hindered by a Faraday shield.

4. A medium as recited in claim 1, wherein the long-range wireless service is selected from a group consisting of pager service, personal communication service, cellular communications, satellite communications, global positioning system (GPS) service, GPRS, and IEEE 802.11.

5. A medium as recited in claim 1, wherein the short-range wireless service is selected from a group consisting of Bluetooth, IEEE 802.15.4, IEEE 802.11 , and Infrared (IR).

6. A signal-forwarding device comprising:
a processor;
a long-range wireless service receiver;
a short-range wireless service transmitter;
a medium as recited in claim 1.

7. A computer-readable medium having computer-executable instructions that, when executed by a computer, performs a method comprising:
receiving a short-range wireless service having a protocol for encoding data into a signal of the short-range wireless service;
decoding the protocol of the short-range wireless service;
converting the results of the decoding into a protocol of a long-range wireless service having a protocol for encoding data into a signal of the long-range wireless service;
sending the converted results via the long-range wireless service.

8. A medium as recited in claim 7, wherein the signal of the long-range wireless service is relatively weak compared to the signal of the short-range wireless service.

9. A medium as recited in claim 7, wherein, as compared to the signal of the short-range wireless service, the signal of the long-range wireless service is more easily hindered by a Faraday shield.

10. A medium as recited in claim 7, wherein the long-range wireless service is selected from a group consisting of pager service, personal communication service, cellular communications, satellite communications, global positioning system (GPS) service, GPRS, and IEEE 802.11.

11. A medium as recited in claim 7, wherein the short-range wireless service is selected from a group consisting of Bluetooth, IEEE 802.15.4, IEEE 802.11, and Infrared (IR).

12. A signal-forwarding device comprising:
a processor;
a long-range wireless service receiver;
a short-range wireless service transmitter;
a medium as recited in claim 7.

13. A computer-readable medium having computer-executable instructions that, when executed by a computer, performs a method comprising:
receiving a first wireless service having a protocol for encoding data into a signal of the service;
decoding the protocol of the first wireless service;
converting the results of the decoding into a protocol of a second wireless service having a protocol for encoding data into a signal of the service;
sending the converted results via the second wireless service;
wherein the first and second wireless services are different.

14. A medium as recited in claim 13, wherein the signal of one of the first and second wireless services is relatively weak compared to the signal of the other.

15. A medium as recited in claim 13, wherein, as compared to the signal of the other service, the signal of one of the first and second wireless services is more easily hindered by a Faraday shield.

16. A medium as recited in claim 13, wherein one of the first and second wireless services is selected from a group consisting of pager service, personal communication service, cellular communications, satellite communications, global positioning system (GPS) service, GPRS, and IEEE 802.11.

17. A medium as recited in claim 13, wherein one of the first and second wireless services is selected from a group consisting of Bluetooth, IEEE 802.15.4, IEEE 802.11, and Infrared (IR).

18. A signal-forwarding device comprising:
a processor;
a receiver for one of the first and second wireless services;
a transmitter for other service;
a medium as recited in claim 13.

19. A method for wireless signal forwarding, the method comprising:
receiving a first wireless service having a protocol for encoding data into a signal of the service;
decoding the protocol of the first wireless service;
converting the results of the decoding into a protocol of a second wireless service having a protocol for encoding data into a signal of the service;
sending the converted results via the second wireless service;
wherein the first and second wireless services are different.

20. A method as recited in claim 19, wherein the signal of one of the first and second wireless services is relatively weak compared to the signal of the other.

21. A method as recited in claim 19, wherein, as compared to the signal of the other service, the signal of one of the first and second wireless services is more easily hindered by a Faraday shield.

22. A method as recited in claim 19, wherein one of the first and second wireless services is selected from a group consisting of pager service, personal communication service, cellular communications, satellite communications, global positioning system (GPS) service, GPRS, and IEEE 802.11.

23. A method as recited in claim 19, wherein one of the first and second wireless services is selected from a group consisting of Bluetooth, IEEE 802.15.4, IEEE 802.11, and Infrared (IR).

24. A wireless-signal forwarding system comprising:
a receiver configured to receive a first wireless service having a protocol for encoding data into a signal of the service;
a decoder configured to decode the protocol of the first wireless service;
a protocol converter configured to convert the results of the decoding into a protocol of a second wireless service having a protocol for encoding data into a signal of the service;
a transmitter configured to send the converted results via the second wireless service;
wherein the first and second wireless services are different.

25. A system as recited in claim 24 further comprising a battery-based power source.

26. A system as recited in claim 24, wherein the signal of one of the first and second wireless services is relatively weak compared to the signal of the other.

27. A system as recited in claim 24, wherein, as compared to the signal of the other service, the signal of one of the first and second wireless services is more easily hindered by a Faraday shield.

28. A system as recited in claim 24, wherein one of the first and second wireless services is selected from a group consisting of pager service, personal communication service, cellular communications, satellite communications, global positioning system (GPS) service, GPRS, and IEEE 802.11.

29. A system as recited in claim 24, wherein one of the first and second wireless services is selected from a group consisting of Bluetooth, IEEE 802.15.4, IEEE 802.11, and Infrared (IR).

30. A system as recited in claim 24 further comprising an affixation mechanism configured to affix the system to a body.

31. A system as recited in claim 30, wherein the body is a Faraday shield.

32. A system as recited in claim 30, wherein the body is selected from a group consisting of an automobile, a house, a boat, a train, an airplane, a transportation vehicle, a building, and a tunnel.

33. A system as recited in claim 30, wherein the affixation mechanism configured to permanently affix the system to the body.

34. A system as recited in claim 30, wherein the affixation mechanism configured to temporarily affix the system to the body.

35. A system as recited in claim 30, wherein the affixation mechanism selected from a group consisting of magnets, adhesive, rivets, screw fasteners, clamp fasteners, and suction cups.
